(19) United States
(12) Patent Application Publication
(10) Pub. No.: US 2015/0073865 A1
(43) Pub. Date: Mar. 12, 2015

(54) DATA VISUALIZATION AND USER INTERFACE FOR MONITORING AND PREDICTION OF DEAL PERFORMANCE

(71) Applicant: Oracle International Corporation, Redwood Shores, CA (US)

(72) Inventors: Dave Stephens, Half Moon Bay, CA (US); Jeffrey Pease, San Francisco, CA (US); Heather Weir, Sunnyvale, CA (US); Daniel Valdivia Milanes, Belmont, CA (US); Fernando Francisco Dingler Avilez, Redwood Shores, CA (US); Bao Liu, Santa Clara, CA (US)

(73) Assignee: Oracle International Corporation, Redwood Shores, CA (US)

(21) Appl. No.: 14/025,742

(22) Filed: Sep. 12, 2013

(51) Int. Cl. G06Q 30/02

(52) U.S. Cl. CPC G06Q 30/0202
USPC 705/7.31

(57) ABSTRACT

Data visualizations and user interfaces help managers monitor progress in meeting their performance targets and explore hypothetical situations for meeting performance targets. A pending deal visualization is partitioned into first and second portions representing times prior to and following a performance period deadline. Deal icons are arranged in either portion based on their expected deal closing dates. Deal icons may also be positioned based on their probabilities of successful completion. A performance goal visualization includes indicators for the progress towards a performance goal. A user may move deal icons between the first and second portions in the pending deal visualization to explore hypothetical changes in deal closing dates and view the impact on goal progress in the performance goal visualization. Proposed changes to expected deal closing dates may be saved for future reference and/or distributed to other users to act on these changes.

### CROSS REFERENCES TO RELATED APPLICATIONS

This application is related to the following applications, Attorney Docket Number—ORACP0104, U.S. patent application Ser. No. ______, entitled DEAL STAGE DATA VISUALIZATION AND USER INTERFACE, filed on Sep. 12, 2013, and Attorney Docket Number—ORACP0105, U.S. patent application Ser. No. ______, entitled DATA VISUALIZATION AND USER INTERFACE FOR MONITORING RESOURCE ALLOCATION TO CUSTOMERS, filed on Sep. 12, 2013, which are hereby incorporated by reference, as if set forth in full in this specification.

### BACKGROUND

This application relates to the field of user interfaces for visualizing and forecasting deal and other enterprise data. Customer Relation Management (CRM) applications are intended to organize and automate interactions between an organization's representatives, such as salespeople, and the organization's customers and potential customers. CRM applications can assist organizations with managing interactions with customers and potential customers in a number of different ways.

Monitoring the activity of salespeople on deal opportunities is one task typically performed by CRM applications. Deal managers may view the data collected by CRM applications to monitor the activities of their salespeople. One task for managers is to ensure that their sales organizations meet their near-term and long-term targets. To do this, it is important for managers to be able to identify whether they are on track to meet their performance targets. Additionally, if managers are facing potential shortfalls in their sales goals, it is important for managers to be able to identify any deal opportunities in progress that could be given additional resources to accelerate deal completion and meet their targets.

Unfortunately, current CRM applications do not make it easy for deal managers to view the totality of deal opportunities in progress, to identify potential shortfalls, and to identify potential deal opportunities that could be used to make up any shortfalls. Current CRM applications often present deal opportunity data in a tabular format and require deal managers to sort and manually analyze columns of data to understand the overall status of the deal opportunities in progress. Additionally, current CRM applications do not make it easy for managers to explore hypothetical situations for meeting performance targets.

### SUMMARY

An embodiment of the invention includes a set of data visualizations and user interfaces adapted to help deal managers determine whether they are on track to meet their performance targets, identify specific deal opportunities that could be used to make up any shortfalls, and to explore hypothetical situations for meeting performance targets.

An embodiment of the data visualizations and user interface includes a pending deal visualization. The pending deal visualization includes a first axis representing expected deal closing dates. The pending deal visualization is partitioned into a first portion representing time prior to a performance period deadline and a second portion representing time following the performance period deadline. Deal icons, each representing an individual pending deal, are arranged in either the first or second portions based on their respective expected deal closing dates. In another embodiment, a second axis represents expected deal win probabilities and each deal icon is positioned with respect to the second axis based on its respective probability of successful completion.

A further embodiment of the invention includes a performance goal visualization that includes at least a first aggregate value indicator. The first aggregate value indicator indicates the aggregate value of the portion of the deal icons positioned in the first portion of the pending deal visualization. In still a further embodiment, the performance goal visualization includes a second indicator of the total value of the performance goal for the pending performance period and a third indicator of the total progress towards this performance goal, including the value of deals already completed in the current performance period.

In yet another embodiment, the data visualization and user interface includes user interface functions for selecting one or more individual deal icons and moving the selected deal icons from the second portion to the first portion of the pending deal visualization, or vice-versa, to explore hypothetical changes to the selected deals' closing dates. As the user changes expected deal closing dates from the next performance period to the current performance period, the aggregate value and performance goal progress indicators in the performance goal visualization are updated accordingly. In still a further embodiment, the proposed changes to expected deal closing dates may be saved for future reference and/or distributed to other users to act on these changes.

A further understanding of the nature and the advantages of particular embodiments disclosed herein may be realized by reference of the remaining portions of the specification and the attached drawings.

### BRIEF DESCRIPTION OF THE DRAWINGS

The invention will be described with reference to the drawings, in which:

FIG. 1 illustrates an example data visualization and user interface according to an embodiment of the invention;

FIG. 2 illustrates an example first detail view of the data visualization and user interface according to an embodiment of the invention;

FIG. 3 illustrates an example second detail view of the data visualization and user interface according to an embodiment of the invention;

FIG. 4 illustrates an example filtering function in the data visualization and user interface according to an embodiment of the invention;

FIG. 5 illustrates example exploration functions for evaluating hypothetical situations in the data visualization and user interface according to an embodiment of the invention and

FIG. 6 illustrates an example system suitable for implementing embodiments of the invention.

### DETAILED DESCRIPTION OF EMBODIMENTS

An embodiment of the invention includes a set of data visualizations and user interfaces adapted to help deal managers determine whether they are on track to meet their performance targets, identify specific deal opportunities that could be used to make up any shortfalls, and to explore hypothetical situations for meeting performance targets.

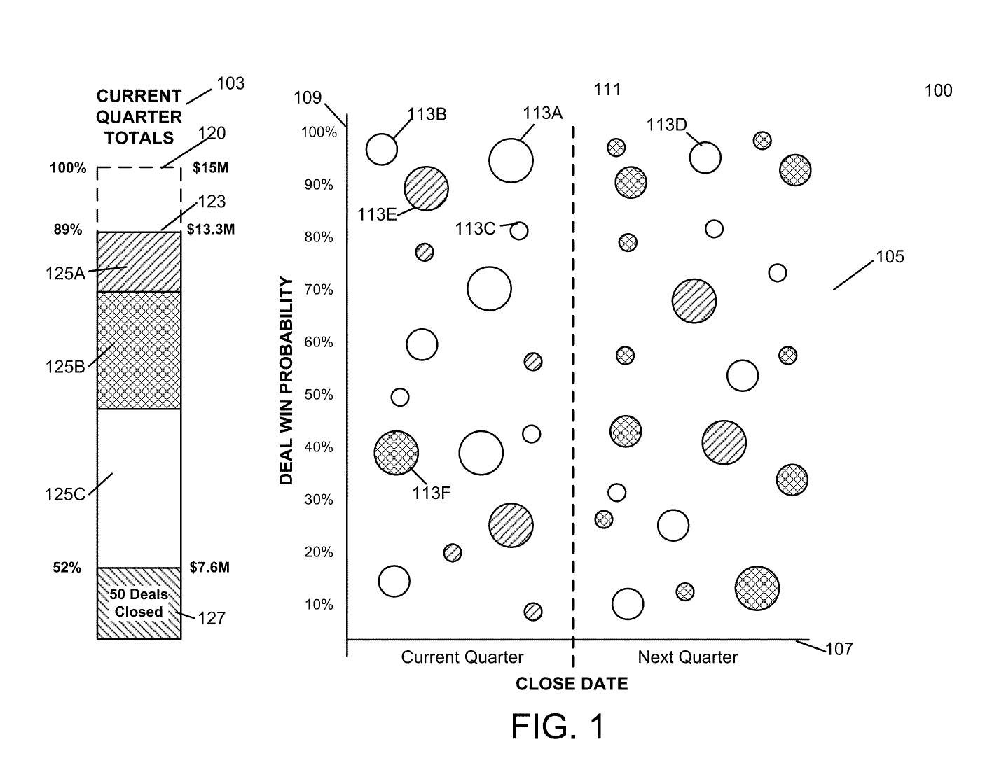

FIG. 1 illustrates an example data visualization and user interface 100 according to an embodiment of the invention. Example 100 includes a performance goal visualization 103 and a pending deal visualization 105.

The performance goal visualization 103 includes a bar graph or other visual indicator of how close the manager, user, or organizational unit is to meeting a performance goal, such as quarterly sales goal or any other type of performance metric. In an embodiment, the performance goal visualization 103 includes visual, text, and/or numeric indicators of the current goal 120, the current expected progress 123 towards this goal, pending deals in categories of interest, and deals that have closed. In example 100, the performance goal visualization 103 indicates that the user's current expected progress 123 is at 89% or $13.3M towards a goal 120 of $15M in quarterly sales.

In a further embodiment, the performance goal visualization 103 provides a breakdown of the current expected progress 123 towards the performance goal into several categories 125, including categories 125A, 125B, and 125C. Each of the categories 125 may be colored, shaded, and/or patterned to visually distinguish it from other categories. Categories may include a specific deal region, product category, management or deal group, industry or market segment, or any other category associated with the pending deals, the organization, or the potential customers. Embodiments of the invention may utilize any number of categories as applicable to the data under analysis and the three categories shown in this example are for the purposes of illustration and not to limit the scope of the invention.

In this example 100, the visual indicators 125A, 125B, and 125C represent pending deals in different categories that are expected to be completed by the end of the current quarter, which is the performance period under consideration in this example.

Additionally, an embodiment of the pending deal visualization 105 includes a deals closed indicator 127 of the deals already closed. In this example 100, deals closed indicator 127 indicates that 50 deals have been closed, representing 52% and $7.6M of this quarter's performance goal.

The pending deal visualization 105 provides more detailed information about the current expected progress 123 shown in the performance goal visualization. The pending deal visualization 105 includes a horizontal axis 107 representing time and a vertical axis representing an expected deal win probability. Within the pending deal visualization 105, individual pending deals are presented as circular icons 113.

In an embodiment, the pending deal icons 113 are assigned a vertical position based on their expected probability of being successfully completed, which is referred to as a deal win probability. Each deal may be assigned a deal win probability, reflecting the likelihood that the organization will succeed in receiving in deal. Deal win probabilities may be determined by statistical analysis using CRM or other software applications, by evaluation of one or more users, by the application of heuristics, or by any other analysis technique known in the art.

Additionally, the pending deal icons 113 are assigned a horizontal position based on their date of expected closing. In one embodiment, a dividing line 111 indicates the end of the current quarter or any other time limit associated with a performance metric. Pending deal icons 113 located to the left of line 111 are expected to close before the end of the current quarter or other performance deadline. Pending deal icons 113 located to the right of line 111 are expected to close after the end of the current quarter or other performance deadline. In example 100, pending deal icon 113A is located to the left of line 111, indicating that this deal is expected to close before the end of the current quarter, and pending deal icon 113D is located to the right of line 111, indicating that this deal is expected to close after the end of the current quarter.

In one implementation, the horizontal positions of pending deal icons 113 relative to the line 111 are based on the specific expected closing date of the associated deal. In an alternate implementation, pending deal icons 113 are positioned to the left or right of line 111 based on their expected closing dates, but are otherwise not assigned a specific horizontal position based on these dates.

In an additional embodiment, the pending deal icons 113 are scaled in size relative to their potential value, such as the estimated total monetary value of the potential sale. For example, deal icons 113A, 113B, and 113C represent potential deal with high, medium, and low expected monetary value, respectively. In an embodiment, deal icons 113 are restricted to two or more discrete sizes and each deal is assigned to one of the available icon sizes based on its absolute or relative value. In an alternate embodiment, deal icons may have any size between a minimum and maximum icon size based on their relative values.

In a further embodiment, deal icons 113 may be assigned color or shading based on their membership in one or more categories. For example, deal icons may be colored or shaded to indicate their membership in a specific deal region, product category, management or deal group, industry or market segment, or any other category associated with the deal, the organization, or the potential customer. For example, deal icons 113A-113C are shaded similarly to indicate their association with a first management unit; deal icons 113E is shaded to indicate its association with a second management unit; and deal icons 113F is shaded to indicate its association with a third management unit. Embodiments of the invention may utilize any number of categories as applicable to the data under analysis and the three categories shown in this example are for the purposes of illustration and not to limit the scope of the invention.

In a yet a further embodiment, the shading or coloring of deal icons 113 matches the shading or coloring of the categories 125 shown in the performance goal visualization 103. In this embodiment, the categories 125 displayed in the performance goal visualization 103 correspond with the categories associated with the deal icons 113 in the pending deal visualization.

The performance goal visualization 103 and pending deal visualization 105 in example 100 provide users with a clear visualization of whether their sales organizations are meeting their near-term and long-term targets. Additionally, the use of categories, filters, and detail views, as described below, enable users to identify specific areas performing above or below expectations.

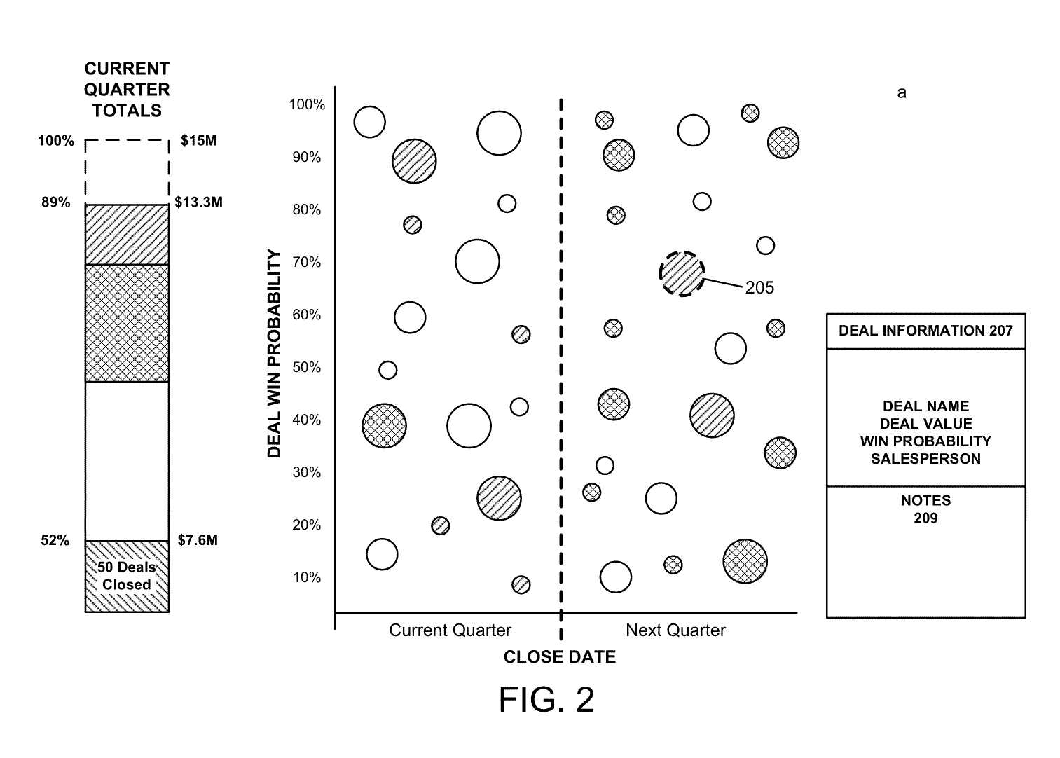

In addition to viewing information about deals as described in example 100, a further embodiment of the invention provides detailed information on specific deals. FIG. 2 illustrates an example first detail view 200 of the data visualization and user interface according to an embodiment of the invention.

Example 200 includes performance goal visualizations and pending deal visualizations including deal icons, similar to example 100 discussed above. Upon receiving a user selection of one or more of the deal icons, example 200 presents additional information about this specific deal in a panel or window. For example, if a user selects deal icon 205, panel 207 will be displayed with additional information about this associated deal.

Examples of additional deal information include, but are not limited to: the deal name, the deal value, the deal win probability, the responsible salesperson or team, the length that the deal has been pending, the sales stage that the deal is in, the amount of time that the deal has been in its current sales stage, the deal forecast, the estimated deal close date, potential deal competitors, and the status of the deal.

In a further embodiment, the panel 207 may include an area 209 for the user to enter notes about the deal. In yet a further embodiment, these notes may be recorded in a CRM or other application and/or distributed to other individuals or groups associated with the selected deal.

In an embodiment, a user may tap an icon to dismiss panel 207 or a different deal icon to view its deal information.

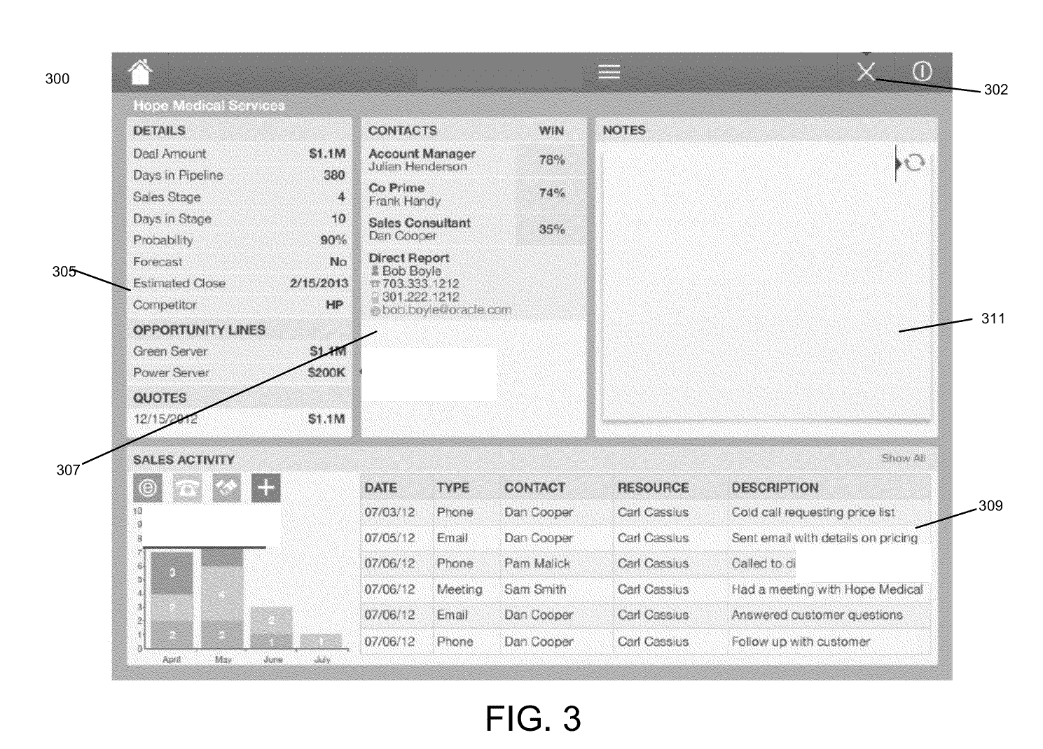

FIG. 3 illustrates an example second detail view 300 of the data visualization and user interface according to an embodiment of the invention. In an embodiment, the second detail view 300 may be displayed with a user selects an icon in a panel 207 for a selected deal in detail view 200. Selecting an icon 302 in the second detail view 300 closes this view and returns to detail view 200 or the data presentation example 100.

In the second detail view 300, a user may view addition specific information about the pending deal, including a summary of the deal information 305, deal contact information 307, recent activity associated with the deal 309, and notes 311 about the deal. Notes 311 may be edited, added, saved to a CRM or other application, and/or distributed to other users via this view. Deal information may be displayed in detail view 300 in tabular and/or graphical format. Scrolling, filtering, searching, and/or sorting functions may also be included to assist users in retrieving information about the deal.

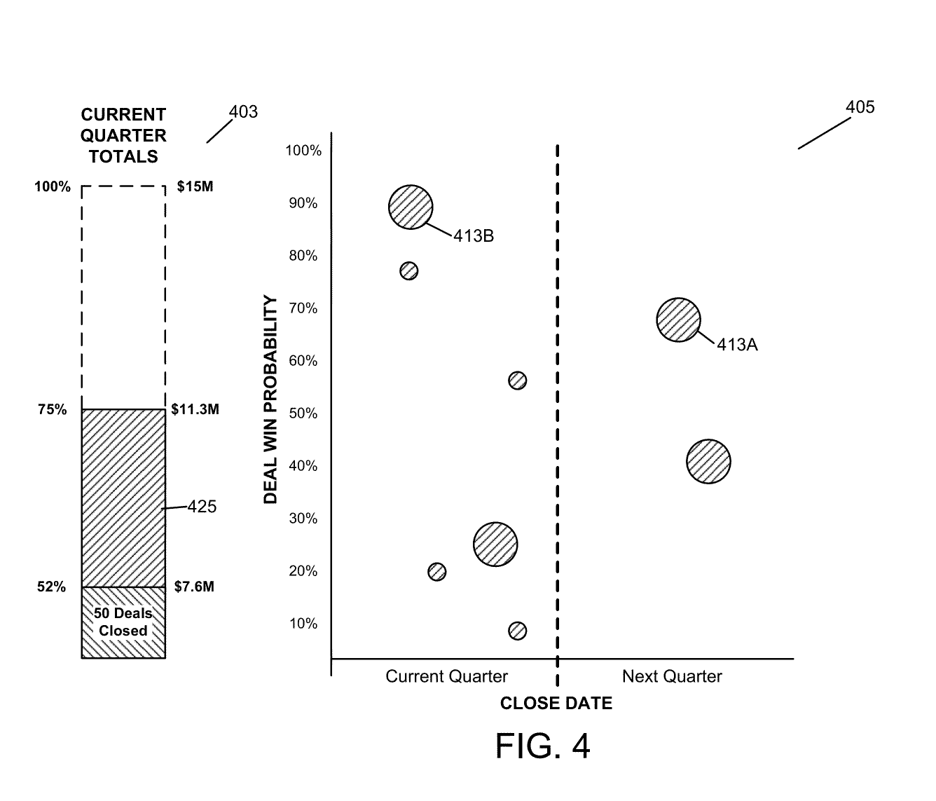

FIG. 4 illustrates an example 400 of filtering functions in the data visualization and user interface according to an embodiment of the invention. In this embodiment, a user may apply one or more filters to expand or restrict the number and/or type of deals presented in this data visualization and user interface. Example filters include deal sizes, time frames, specific deal region, product category, management or deal group, industry or market segment, or any other category associated with the deal, the organization, or the potential customer. Filters may be enabled, disabled, and configured through the use of menu items, user interface buttons, and/or any other types of user interface input widgets or elements known in the art.

In response to one or more filters being enabled, the performance goal visualization 403 and pending deal visualization 405 are updated accordingly. For example, if a user enables a filter to show deal information associated with only a single category, then the performance goal visualization 403 will show the total value of pending deals in the selected category expected to close in the current quarter using indicator 425. In this example 400, indicators representing the total values of pending deals in other categories not selected by the filter are hidden from view.

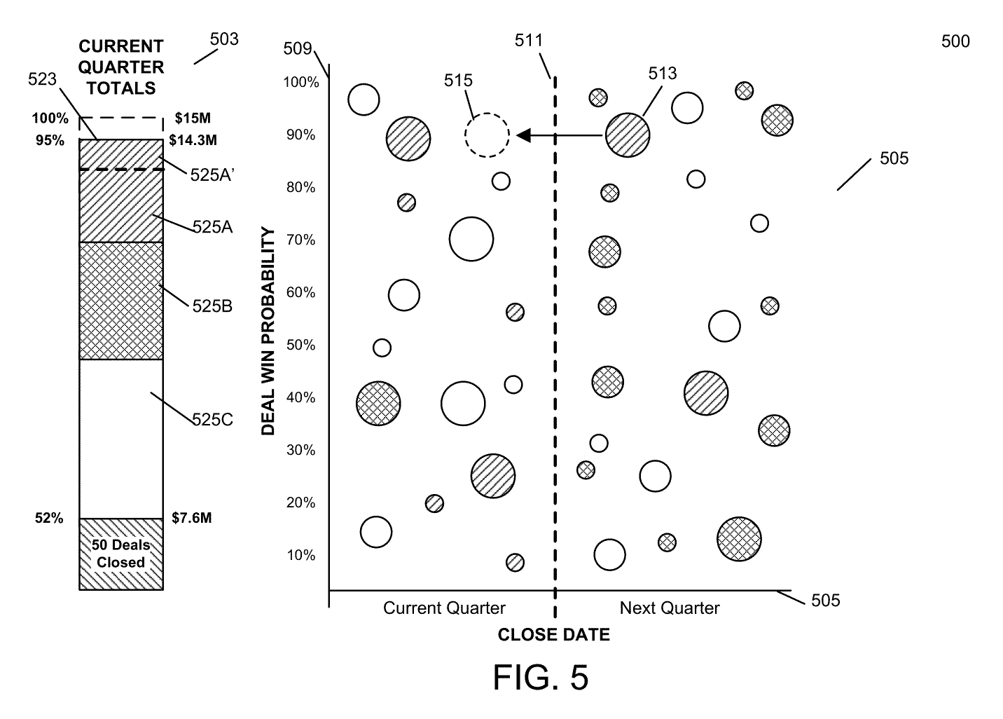

In a further embodiment, the data visualization and user interface may also be used to evaluate hypothetical situations. FIG. 5 illustrates example exploration functions for evaluating hypothetical situations in the data visualization and user interface according to an embodiment of the invention. In FIG. 5, an example data visualization and user interface 500 includes a performance goal visualization 503 and a pending deal visualization 505.

As in example 100, the performance goal visualization 503 includes a bar graph or other visual indicator of how close the manager, user, or organizational unit is to meeting a performance goal, such as quarterly sales goal or any other type of performance metric. The performance goal visualization 503 also provides a breakdown of the current expected progress 523 towards the performance goal into several categories 125, including category 525A, 125B, and 125C. Although only three categories are shown in example 500, embodiments of the invention may be implemented with any arbitrary number of categories. In this example 500, the visual indicators 525A, 525B, and 525C represent pending deals in different categories that are expected to be completed by the end of the current quarter, which is the performance period under consideration in this example.

The pending deal visualization 505 provides more detailed information about the current expected progress 523 shown in the performance goal visualization. The pending deal visualization 505 includes a horizontal axis 507 representing time and a vertical axis representing an expected deal win probability. Pending deal icons, such as pending deal icon 513, are assigned a vertical position based on their deal win probability and a horizontal position based on their date of expected closing. The dividing line 511 indicates the end of the current quarter or any other time limit associated with a performance metric. Pending deal icons located to the left of line 511 are expected to close before the end of the current quarter or other performance deadline and those located to the right of line 511 are expected to close after the end of the current quarter or other performance deadline.

Embodiments of the invention allow users to explore hypothetical situations by manipulating deal icons in the pending deal visualization 505 to set hypothetical values for pending deals and viewing the results of these hypothetical values on performance metrics in the performance goal visualization.

For example, a user may select deal icon 513, located on the right side of line 511 and drag or move it to the left side of line 511. This creates a hypothetical situation in which this pending deal's expected closing date is before, rather than after, the current quarter's closing date. In response to this user interaction, the current expected progress 523 in performance goal visualization 503 is updated to include the value of the selected deal hypothetically closing in the current quarter.

In a further embodiment, the indicators associated with deal categories 525 are also updated in response to user interactions. For example, deal icon 513 is shaded to indicate the deal's association with category 525A in the performance goal visualization 503. In response to a user moving deal icon 513 to position 515 to indicate a hypothetical closing date in the current quarter, this embodiment of the invention resizes indicator 525A to 525A′ to represent the value added by deal icon 513.

In a still a further embodiment, users may manipulate multiple deal icons, moving some deals forward to close in the current quarter and/or moving some deals back to close in the next quarter. In response to each change, an embodiments of the invention updates the current progress indicator and optionally one or more category indicators 525 to indicate the values of deals added and/or removed from the current quarter or other performance time period.

By letting users interactively experiment with moving one or more deals' closing dates into and out of the current quarter or other performance time period, users can identify deal opportunities that may be accelerated to make up for potential shortfalls elsewhere and meet overall performance targets.

In another embodiment, a user interface element, such as a button, may be used to undo any hypothetical changes to deals potential closing date and reset the performance goal visualization 503 and pending deal visualization 505 to their previous states, with deal icons arranged based on their expected closing dates instead of hypothetical closing dates.

In still another embodiment, a user may select user interface element, such as a button, to record all of the current hypothetical changes to deal closing dates in the data visualization 500 as a change list, a report, or other type of record. This change list may be saved by the user and/or distributed (in whole or in part) at the user's direction to one or more other users via e-mail, communications within a CRM application, or any other type of electronic communications. For example, after making changes to the closing dates of deal in two or more categories, such as two or more sales regions, a sales manager may distribute the entire change list to his or her supervisor, portions of the change list covering specific regions to the respective regional managers, and information on individual changed deals to the assigned salespeople.

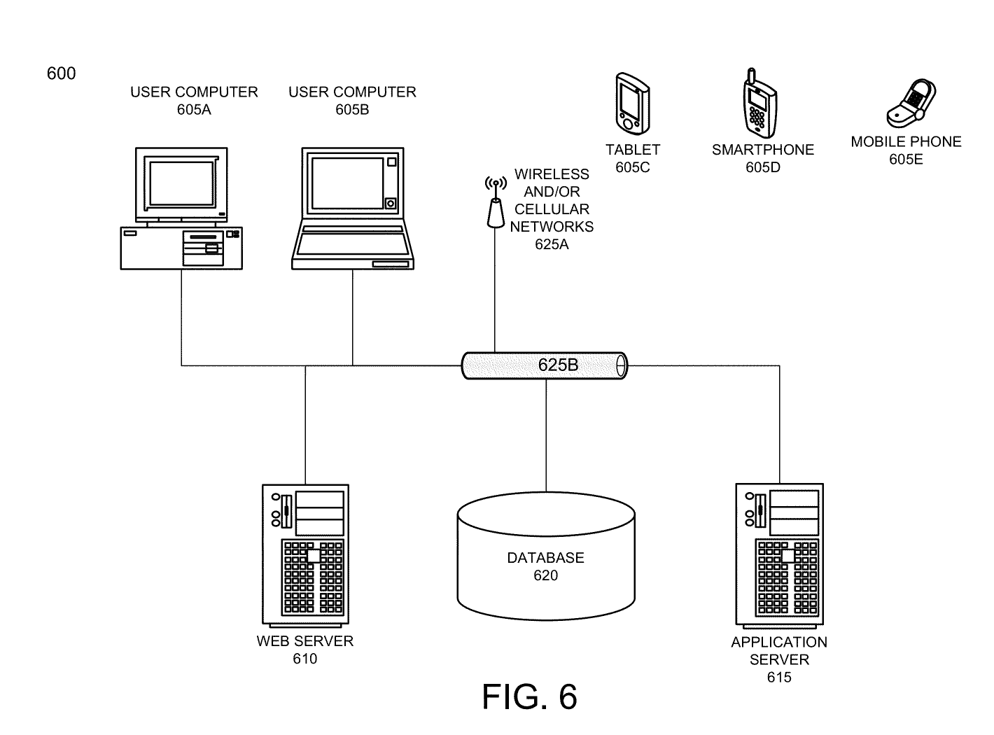

FIG. 6 illustrates an example system 600 suitable for implementing embodiments of the invention. Embodiments of the invention may be implemented as standalone applications or as web-based applications implemented using a combination of client-side and server-side code. FIG. 6 shows an example computer and network system architecture 600 suitable for implementing embodiments of the invention. The system includes user computers 605 including desktop 605A and portable personal computers 605B, tablets 605C, smartphones 605D, and mobile phones 605E. The system can interface with any type of electronic device, such as a thin-client computer, Internet-enabled mobile telephone, mobile Internet access device, tablet, electronic book, or personal digital assistant, capable of displaying and navigating web pages or other types of electronic documents and/or executing applications. Although the system 600 is shown with five user computers, any number of user computers can be supported.

A web server 610 is used to process requests from web browsers and standalone applications for web pages, electronic documents, enterprise data or other content, and other data from the user computers. The server 610 may also provide the menu application, as well as syndicated content, such as RSS feeds, of data related to enterprise operations.

Application server 615 operates one or more mobile applications. The mobile applications can be implemented as one or more scripts or programs written in any programming language, such as Java, C, C++, C#, or any scripting language, such as JavaScript or ECMAScript, Perl, PHP, Python, Ruby, or TCL. Data applications can be built using libraries or application frameworks, such as Rails, Enterprise JavaBeans, or .NET.

The data applications on application server 615 process input data and user computer requests and can store or retrieve data from database 620. Database 620 stores data created and used by the data applications. In an embodiment, the database 620 is a relational database that is adapted to store, update, and retrieve data in response to SQL format commands or other database query languages. In other embodiments, unstructured data storage architectures and NoSQL databases may also be used.

In an embodiment, the application server 615 is one or more general-purpose computers capable of executing programs or scripts. In an embodiment, the web server 610 is implemented as an application running on one or more general-purpose computers. The web server and application server may be combined and executed on the same computers.

An electronic communication network 625 enables communication between user computers 605, web server 610, application server 615, and database 620. In an embodiment, network 625 may further include any form of electrical or optical communication devices, including wireless 625A and wired 625B networks. Network 625 may also incorporate one or more local-area networks, such as an Ethernet network; wide-area networks, such as the Internet and cellular carrier data networks; and virtual networks, such as a virtual private network.

The system is one example for executing mobile applications according to an embodiment of the invention. In another embodiment, application server, web server, and optionally database can be combined into a single server computer application and system. In a further embodiment, virtualization and virtual machine applications may be used to implement one or more of the application server, web server, and database. In still further embodiments, all or a portion of the web server and application functions may be integrated into an application running on each of the user computers. For example, a JavaScript application on the user computer may be used to retrieve or analyze data and display portions of the applications.

Although the description has been described with respect to particular embodiments thereof, these particular embodiments are merely illustrative, and not restrictive. Any suitable programming language can be used to implement the routines of particular embodiments. Any type of programming techniques may be employed including procedural, functional, and/or object oriented programming techniques. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method of presenting deal forecast information, the method comprising:
generating a pending deal visualization including:
a partitioning of the pending deal visualization along a first axis representing expected deal closing dates into a first portion representing time prior to a performance period deadline and a second portion representing time following the performance period deadline; and
deal icons, wherein each deal icon represents an individual pending deal and is positioned in either the first or second portion of the pending deal visualization based on its respective pending deal's expected closing date;
generating a performance goal visualization including:
at least one aggregate value indicator, indicating the aggregate value of the portion of the deal icons positioned in the first portion of the pending deal visualization; and
providing the pending deal visualization and performance goal visualization for display by an electronic device.

2. The method of claim 1, comprising:
receiving at least one user input selecting and moving a first one of the deal icons from the first portion to the second portion or from the second portion to the first portion;
in response to the user input, modifying the aggregate value indicator in the performance goal visualization based on a value of a first pending deal, wherein the first pending deal is associated with the selected deal icon.

3. The method of claim 2, comprising:
adding the first pending deal to a set of modified deals; and
distributing at least a portion of the set of modified deal to an additional user.

4. The method of claim 1, wherein the pending deal visualization includes a second axis representing a deal completion probability, and wherein each of the deal icons is positioned with respect to the second axis based on a deal completion probability value assigned to its respective pending deal.

5. The method of claim 1, wherein each deal icon is scaled based on a value of its respective pending deal.

6. The method of claim 1, wherein each deal icon is colored or shaded based on a category value associated with its respective pending deal.

7. The method of claim 6, wherein the aggregate value indicator in the performance goal visualization is associated with the category value and is colored or shaded based on the category value of its respective pending deals.

8. The method of claim 6, wherein the category value belongs to at least one category including deal region, product category, management group, deal group, industry segment, and/or market segment.

9. The method of claim 1, comprising:
receiving at least one user input selecting a first one of the deal icons; and
in response to the user input, generating a display of additional deal information from its respective pending deal.

10. The method of claim 1, comprising:
receiving at least one user input specifying at least one filtering parameter; and
in response to the user input:
removing at least a portion of the deal icons from the pending deal visualization that do not satisfy the filtering parameter; and
modifying the aggregate value indicator to represent an aggregate value of the remaining deal icons positioned in the first portion of the pending deal visualization.

11. A tangible, computer-readable information storage medium including instructions adapted to direct a computer to display a user interface, the user interface comprising:
a pending deal visualization including first and second portions arranged with respect to a first axis to represent time before and after a performance period deadline, respectively;
deal icons, wherein each deal icon represents an individual pending deal and is positioned in either the first or second portion of the pending deal visualization based on its respective pending deal's expected closing date;
a performance goal visualization including at least one aggregate value indicator that indicates the aggregate value of the portion of the deal icons positioned in the first portion of the pending deal visualization.

12. The tangible, computer-readable information storage medium of claim 11, comprising:
a user interface input for receiving a user selection and movement of at least a first one of the deal icons from the first portion to the second portion or from the second portion to the first portion of the pending deal visualization; and
a performance goal visualization update function for modifying the aggregate value indicator in the performance goal visualization based on a value of a first pending deal in response to the user selection and movement of the first one of the deal icons via the user interface input, wherein the first pending deal is associated with the selected deal icon.

13. The tangible, computer-readable information storage medium of claim 12, comprising:
a change recording user interface input for adding the first pending deal to a set of modified deals and distributing at least a portion of the set of modified deal to an additional user.

14. The tangible, computer-readable information storage medium of claim 11, wherein the pending deal visualization includes a second axis representing a deal completion probability, and wherein each of the deal icons is positioned with respect to the second axis based on a deal completion probability value assigned to its respective pending deal.

15. The tangible, computer-readable information storage medium of claim 11, wherein each deal icon is scaled based on a value of its respective pending deal.

16. The tangible, computer-readable information storage medium of claim 11, wherein each deal icon is colored or shaded based on a category value associated with its respective pending deal.

17. The tangible, computer-readable information storage medium of claim 16, wherein the aggregate value indicator in the performance goal visualization is associated with the category value and is colored or shaded based on the category value of its respective pending deals.

18. The tangible, computer-readable information storage medium of claim 11, comprising:
a deal detail user interface input for receiving a user input and generating a display of additional deal information associated with a selected one of the deal icons in response to the user input.

19. The tangible, computer-readable information storage medium of claim 11, comprising:
a deal filtering user interface input for receiving a user input specifying at least one filtering parameter; and in response to the user input, removing at least a portion of the deal icons from the pending deal visualization that do not satisfy the filtering parameter; and modifying the aggregate value indicator to represent an aggregate value of the remaining deal icons positioned in the first portion of the pending deal visualization.

20. A system comprising:
a client system;
a database storing pending deal data; and
an application server connected with the database and the client system via at least one network, wherein the application server is adapted to retrieve the deal data from the database and communicate the retrieved deal data with the client system;
wherein the client system includes an application including instructions executable by the client system to perform a method, the method comprising:
generating a pending deal visualization including:
a partitioning of the pending deal visualization along a first axis representing expected deal closing dates into a first portion representing time prior to a performance period deadline and a second portion representing time following the performance period deadline; and
deal icons, wherein each deal icon represents an individual pending deal and is positioned in either the first or second portion of the pending deal visualization based on its respective pending deal's expected closing date;
generating a performance goal visualization including:
at least one aggregate value indicator, indicating the aggregate value of the portion of the deal icons positioned in the first portion of the pending deal visualization; and
providing the pending deal visualization and performance goal visualization for display by an electronic device.
